(19) United States
(12) Patent Application Publication
(10) Pub. No.: US 2023/0280739 A1
(43) Pub. Date: Sep. 7, 2023

(54) HISTOGRAM MODEL FOR CATEGORICAL ANOMALY DETECTION

(71) Applicant: NEC Laboratories America, Inc., Princeton, NJ (US)

(72) Inventors: Peng Yuan, Princeton, NJ (US); LuAn Tang, Pennington, NJ (US); Haifeng Chen, West Windsor, NJ (US); Motoyuki Sato, Cupertino, CA (US)

(21) Appl. No.: 18/173,452

(22) Filed: Feb. 23, 2023

Related U.S. Application Data
(60) Provisional application No. 63/315,141, filed on Mar. 1, 2022.
(60) Provisional application No. 63/337,839, filed on May 3, 2022.

(51) Int. Cl. G05B 23/02

(52) U.S. Cl. CPC G05B 23/0283

(57) ABSTRACT

Methods and systems for anomaly detection include training an anomaly detection histogram model using historical categorical value data. Training the anomaly detection histogram model includes generating a histogram template based on historical categorical data, converting the historical categorical data to a histogram using the histogram template, and determining a normal range and anomaly threshold for the categorical data using the histogram.

### RELATED APPLICATION INFORMATION

This application claims priority to U.S. Patent Application No. 63/337,839, filed on May 3, 2022, and to U.S. Patent Application No. 63/315,141, filed on Mar. 1, 2022, each incorporated herein by reference in its entirety. This application is related to an application entitled “EXPLAINABLE ANOMALY DETECTION FOR CATEGORICAL SENSOR DATA,” having attorney docket number 21117, which is incorporated by reference herein in its entirety.

### BACKGROUND

### Technical Field

The present invention relates to system monitoring and, more particularly, to anomaly detection in systems that include categorical sensor data.

### Description of the Related Art

A cyber-physical system may include a variety of sensors, which may collect a wide variety of information about the system, its operation, and its environment. The collected data may be used to characterize the operational characteristics of the cyber-physical system, for example to determine when the cyber-physical system may be operating outside its expected normal parameters.

### SUMMARY

A method for anomaly detection includes training an anomaly detection histogram model using historical categorical value data. Training the anomaly detection histogram model includes generating a histogram template based on historical categorical data, converting the historical categorical data to a histogram using the histogram template, and determining a normal range and anomaly threshold for the categorical data using the histogram.

A method for anomaly detection includes detecting an anomaly in a time series of categorical data values generated by a sensor. Detecting the anomaly includes framing the time series with a sliding window, generating a histogram for the categorical data values using a histogram template, generating an anomaly score for the time series using an anomaly detection histogram model on the generated histogram, and comparing the anomaly score to an anomaly threshold. A corrective action is performed responsive to the comparison.

A system for anomaly detection includes a hardware processor and a memory that stores a computer program. When executed by the hardware processor, the computer program causes the hardware processor to train an anomaly detection histogram model using historical categorical value data and to detect an anomaly in a time series of categorical data values generated by a sensor. Training of the anomaly detection includes generation of a histogram template based on historical categorical data, conversion of the historical categorical data to a histogram using the histogram template, and determination of a normal range and anomaly threshold for the categorical data using the histogram. Detection of the anomaly includes framing of the time series with a sliding window, generation of a histogram for the categorical data values using a histogram template, generation of an anomaly score for the time series using an anomaly detection histogram model on the generated histogram, and comparison of the anomaly score to an anomaly threshold. The computer program causes the hardware processor to perform a corrective action responsive to the comparison.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a cyber-physical system that generates categorical sensor data, in accordance with an embodiment of the present invention;

FIG. 2 is a block/flow diagram of a method for anomaly detection and correction using a histogram model for categorical sensor data, in accordance with an embodiment of the present invention;

FIG. 3 is a block/flow diagram of a method for converting historical categorical data to histograms, in accordance with an embodiment of the present invention;

FIG. 4 is a diagram of a graphical user interface that helps a user to understand the nature of an anomaly, in accordance with an embodiment of the present invention;

FIG. 5 is pseudo-code for adaptively determining sliding window length for a histogram model, in accordance with an embodiment of the present invention;

FIG. 6 is pseudo-code for generating a three-dimensional histogram template, in accordance with an embodiment of the present invention;

FIG. 7 is pseudo-code for training a histogram model for categorical sensor data, in accordance with an embodiment of the present invention;

FIG. 8 is pseudo-code for detecting anomalies for categorical sensor data, in accordance with an embodiment of the present invention;

FIG. 9 is a block/flow diagram of a method for generating baseline expected time series data, in accordance with an embodiment of the present invention; and

FIG. 10 is a block diagram of a computer system for detecting anomalies in categorical sensor data, in accordance with an embodiment of the present invention.

### DETAILED DESCRIPTION OF PREFERRED EMBODIMENTS

Machine learning models may be used to classify the behavior of a cyber-physical system by monitoring time series data collected and reported from a variety of different sensors within the cyber-physical system. However, whereas many types of sensor generate numerical data, for example as floating-point measurements with any appropriate level of precision, other types of sensor may generate categorical data or binary values.

To handle anomaly detection for cyber-physical systems that report categorical or binary-valued sensor data, a model may be used that is based on histograms. A histogram model may be obtained from the duration of different categorical readings in a training dataset. Such a model may determine normal time ranges for each categorical value and may identify thresholds that are used to detect anomalies. The model may be used for new sensor data to detect anomalies and to identify sensors that may indicate the source of the anomalies.

Such a histogram model may be trained in a semi-supervised manner, for example using a training dataset that represents only normal operation of the cyber-physical system, as data relating to normal operation is easier to obtain than data relating to specific types of anomalies. Such training can provide a robust response to anomalies that are uncommon or novel.

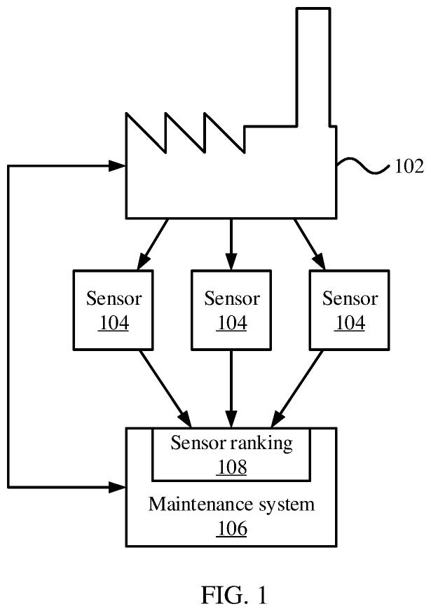

Referring now in detail to the figures in which like numerals represent the same or similar elements and initially to FIG. 1, a maintenance system 106 in the context of a monitored system 102 is shown. The monitored system 102 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems. Exemplary systems 102 may include a wide range of different types, including railroad systems, power plants, vehicle sensors, data centers, satellites, and transportation systems. Another type of cyber-physical system can be a network of internet of things (IoT) devices, which may include a wide variety of different types of devices, with various respective functions and sensor types.

One or more sensors 104 record information about the state of the monitored 416 system 102. The sensors 104 can be any appropriate type of sensor including, for example, physical sensors, such as temperature, humidity, vibration, pressure, voltage, current, magnetic field, electrical field, and light sensors, and software sensors, such as logging utilities installed on a computer system to record information regarding the state and behavior of the operating system and applications running on the computer system. The sensor data may include, e.g., numerical data and categorical or binary-valued data. The information generated by the sensors 104 can be in any appropriate format and can include sensor log information generated with heterogeneous formats.

The sensors 104 may transmit the logged sensor information to an anomaly maintenance system 106 by any appropriate communications medium and protocol, including wireless and wired communications. The maintenance system 106 can, for example, identify abnormal or anomalous behavior by monitoring the multivariate time series that are generated by the sensors 104. Once anomalous behavior has been detected, the maintenance system 106 communicates with a system control unit to alter one or more parameters of the monitored system 102 to correct the anomalous behavior.

Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 106 thereby automatically corrects or mitigates the anomalous behavior. By identifying the particular sensors 104 that are associated with the anomalous classification, the amount of time needed to isolate a problem can be decreased.

Each of the sensors 104 outputs a respective time series, which encodes measurements made by the sensor over time. For example, the time series may include pairs of information, with each pair including a measurement and a timestamp, representing the time at which the measurement was made. Each time series may be divided into segments, which represent measurements made by the sensor over a particular time range. Time series segments may represent any appropriate interval, such as one second, one minute, one hour, or one day. Time series segments may represent a set number of collection time points, rather than a fixed period of time, for example covering 100 measurements.

The maintenance system 106 therefore includes a model that is trained to handle numerical and categorical data. The model may be based on histograms, where a time series may be partitioned into a set of sliding windows and histograms may be built for each categorical value based on the windows. The distribution of histograms may then be used to determine a normal range and threshold for these values, to aid in identifying anomalies.

For a complicated system 106, the number of sensors may be very large, with the sensors reporting independent streams of time-series data. Understanding the cause of a detected anomaly in such a system can be challenging. A model may be trained to detect anomalies in an explainable way, reporting not only an anomaly's time period, type, and value details, but also pro-vide explanations on why the anomaly is abnormal and how normal data would compare. To explain the results of an anomaly detection, anomaly profiles may be stored that help to identify the cause of the anomaly. Expected values may be provided as a normal baseline for comparison.

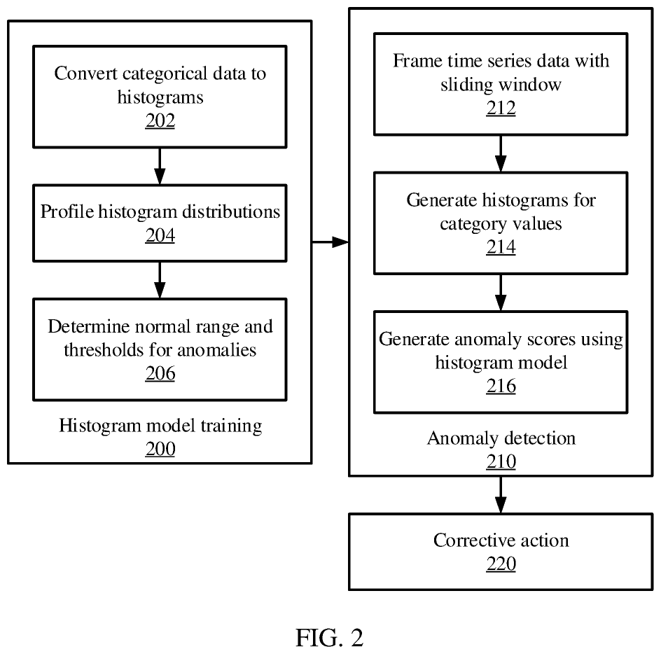

Referring now to FIG. 2, a method of training and using a histogram-based anomaly detection model is shown. Three general steps include training the histogram model in block 200, detecting anomalies using the histogram model in block 210, and performing a corrective action in response to a detected anomaly in block 220. Notably, each of these general steps may be performed by a single entity, or one or more steps may be performed by a separate entity.

Block 200 trains the histogram model using a training dataset, for example using data collected from a cyber-physical system 102 during normal operation of the system. The training dataset may include one or more time series of categorical data. As used herein, categorical data may include any discrete-valued measurement. One example of categorical data is binary-valued data, where each measurement reflects one of two possible values. Categorical data may be represented as an integer, with each distinct integer value corresponding to a different category. Thus, S may be the set of categorical sensors in the cyber-physical system 102, S={s₁, s₂, . . . , sₙ}, with sᵢ being a specific sensor i. The time series measured by sᵢ is denoted as Rᵢ={(v₁,t₁), (v₂,t₂), . . . , (vₘ,tₘ)}, where tⱼ is the j^{th} time stamp and vⱼ∈Vᵢ is the sensor value measured at tⱼ and Vᵢ is the set of unique values that the sensor sᵢ can measure. Thus, given historical sensor readings R₁, R, . . . , Rₙ the model is trained from the historical data and is used to monitor newly arriving data from the sensors s₁,s₂, . . . , sₙ.

For training, block 202 converts the categorical data to histograms, for example using a sliding window. Block 204 profiles the distribution of the histograms and block 206 determines the normal ranges for the categorical values and thresholds for anomalies. The output of block 200 is one or more histogram models that may be used to detect anomalies.

For testing, block 212 takes streaming categorical sensor data as an input and frames the incoming sensor data using a sliding window, for example using the same parameters as the sliding window of block 202. Block 214 generates a histogram for each incoming time series of categorical data and block 216 applies the trained histogram model(s) to the histograms of block 214. Block 216 detects an anomaly if the value of any histogram is higher than a corresponding anomaly threshold.

Block 220 performs a corrective action responsive to the detection of an anomaly. In some examples, the corrective action may include transmission of a signal to the cyber-physical system 102, for example instructing the cyber-physical system 102 to change an operational parameter. One example of a corrective action may be to slow, halt, or restart a process of the cyber-physical system. Another example may be to change an environmental parameter, for example changing an ambient temperature by triggering additional heating or cooling. The corrective action may be performed automatically and without human intervention. The corrective action may be selected in accordance with an explanatory indicator output by the histogram model, for example identifying a sensor that corresponds with the detection of the anomaly.

Training 200 seeks to build an effective model for the normal operational states of the cyber-physical system 102. The categorical data may not have extreme or outlier ranges, which makes it difficult to detect anomalies from the sensor value alone. Duration of a given categorical value may be used instead, as an abnormally long or short duration for a given category may indicate an abnormal state. These durations may be different for different sensors. Using a sliding window of fixed length cannot guarantee accuracy across all sensors, and so the sliding window may be adaptively determined. The use of adaptive windows in block 202 can furthermore reduce noise inference. The repeatability of categories' duration can be used as a reference to determine the length of a sliding window, as described in greater detail below.

Profiling the histogram distributions in block 204 generates respective histograms for the categories of a sensor time series. Different working states of the system 102 may have different degrees of importance, and so the distributions of categories' durations may be different. The histogram for a given categorical value may be subdivided into M equally distant bins, with the height of each bin representing a number of durations that fall into the bin. The histogram may be generated with M equally distant bins for each category as described in greater detail below.

Block 204 may then convert the training data into histograms, partitioning the time series into a set of sliding time windows. The sensor values in the sliding time windows may be converted into corresponding histograms. The time series of a given sensor 104 may have a number of associated histograms that is determined by the number of categories encoded in the data. Each histogram may have a corresponding sliding window. The conversion into histograms is described in greater detail below.

Block 206 uses the histograms to determine normal ranges and threshold for anomalies. A temporal histogram for each bin of histograms and the distribution thereof is approximated. The optimal mean and standard deviation of the temporal histogram are identified and are used to define the normal range and threshold. The Weibull distribution may be used to determine these values, for example selecting the lower bound as:

lower=μ−α₁*σ

and the upper bound as

upper=μ+β₁*σ

where μ is the mean, σ is the standard deviation, and α₁ and β₁ are factors.

During testing in block 210, the framing 212 of a given type of categorical data may be performed using the same sliding window as was used during training framing 202. Block 214 transfers observations in the sliding window to corresponding histograms. However, some category values found by block 214 may not have been present in the training data, and some durations for a given category value may be outside the boundaries of the corresponding histogram. These durations may not accurately translate to the trained histogram(s).

To address this, if block 214 finds a category value that did not appear in the training data, then a high anomaly score may be assigned to the corresponding window. If a duration for a given category value is found that is smaller than the minimum boundary of its corresponding histogram, then the duration may be scored as:

$$score = \frac{\vert duration - minimum bounadry \vert}{minimum boundary}$$

If a duration for a given category value vᵢ is found that is larger than the maximum boundary of its corresponding histogram, then the duration may be scored as:

$$s core = \frac{\vert duration - maximum bounadry \vert}{maximum boundary}$$

Once the remaining observations are converted to histograms, the score of each bin bⱼ may be determined as:

$$score ( {v}_{i} , {b}_{j} ) = \{ \begin{matrix}\frac{\vert frequency - lower bound \vert}{lower bound} & if frequency < lower bound \\ \frac{\vert frequency - upper bound \vert}{upper bound} & if frequency > upper bound \\ 0 & otherwise\end{matrix}$$

where frequency is the height of the bin. The lower and upper bounds are thresholds for anomaly detection determined during training. Once observations are scored, an alert may be generated if any score is higher than a predetermined value. For a histogram hᵢ for sensor sᵢ, the overall anomaly score may be determined as:

$$score ( {h}_{i} ) = {max}_{{b}_{j} ∈ {h}_{i}} ( score ( {v}_{i} , {b}_{j} ) )$$

After computing he anomaly scores for all historical data, the largest score in the histogram is extracted to compute the anomaly threshold for the category vᵢ:

$$δ ( {v}_{i} ) = {max}_{{h}_{i} ∈ {hist\_set}_{i}} ( score ( {h}_{i} ) ( 1 + ε )$$

where ε is a parameter that represents a safe scale range. For example, if ε=20%, that may mean that the score for a real anomaly should be 120% of the historical maximum score in training data.

The trained model is used to monitor streaming data from categorical sensors 104. However, some categorical values may not appear in training data, so the model cannot be trained on such values. Additionally, some events may have very long or very short durations that are outside the boundaries of the histogram model. If a new category value is encountered, one which did not appear in the training data, it may automatically be assigned a relatively high anomaly score. Thus, if a categorical value is found that is not represented within the histogram model, the anomaly score may be set to an above-threshold value.

If an event is found with a duration shorter than the minimum boundary of the histogram model, the system will compute an anomaly score as:

$$score = \frac{\vert duration - lower bound \vert}{lower bound}$$

If an event is found with a duration larger than the maximum boundary, then the system will compute an anomaly score as:

$$score = \frac{\vert duration - upper bound \vert}{upper bound}$$

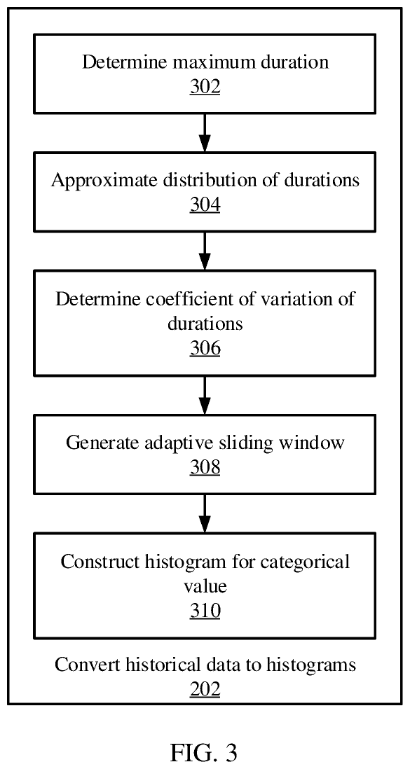

Referring now to FIG. 3, additional detail is shown on the conversion of historical data to histograms in block 202. The repeatability of categories' duration can be used as a reference to determine the length of the sliding window. Block 302 determines a maximum duration for a given categorical value in a time series. A coefficient of variation (CV) may be used to express the repeatability of the category's duration. If the value of CV is small, then the repeatability of the category's duration is high and the category's duration is close to periodic. A larger sliding window may be used for such cases. If the value of CV is relatively large, then the distribution of the category's duration is more complex and a shorter sliding window may be used to sample the time series data.

The CV may be determined by dividing the standard deviation of the duration by the mean. The distribution of a category's duration of training data may not be a Gaussian distribution, so optimal means and standard deviations for the durations may be approximated using the Weibull distribution in block 304. The Weibull distribution is a continuous probability distribution that may be used to analyze life data, model failure times, and access product reliability. Block 304 uses the Weibull distribution to approximate a distribution of categories' durations in the training data and extracts a mean and standard deviation.

Block 306 determines the CV of the durations as:

CV=σ/μ

where σ is the standard deviation and μ is the mean of the event durations. The length of an adaptive sliding window L may then be determined by block 308 as:

$$L = \{ \begin{matrix}{α}_{2} * maximum duration & if 0 \leq c v < t \\ {β}_{2} * maximum duration & if t \leq cv < 1 \\ maximum duration + 1 & otherwise\end{matrix} \begin{matrix} \\ \\ \end{matrix}$$

where α₂, β₂, and t are factors.

With s as a categorical sensor and R as the readings of s, a set of k consecutive readings may be merged into an event eⱼ=(vⱼ, tⱼ, tⱼ₊ₖ) where for an initial timestamp of tⱼ. The sequence may then be transformed as a sequence of categorical events, R={e₁, e₂, . . . , eₘ}. In categorical sensor data, the event may reflect a period of a certain work state of the monitored component of the cyber-physical system, and the start and ends of an event may correspond to system operations, such as turning the component on or off

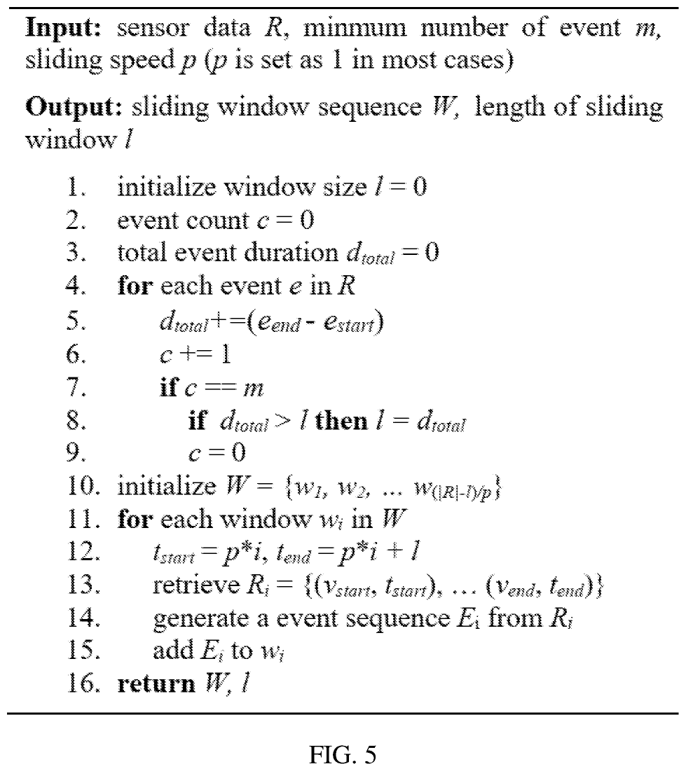

To make a meaningful separation of the sensor data, each sliding window may include a sufficient number of events. Given the sensor data Rᵢ, the minimum number of events m, and the sliding speed p, a window length L may be computed. For example, a total length may be calculated as a sum of event lengths for each event e in a time series R up to sequences of m events, as shown in the following pseudo code of FIG. 5.

Block 310 determines the histograms for the categorical values. Minimum and maximum boundaries of the histogram may be determined based on the mean and standard deviation and the histogram may be split into M equally distant bins, with the horizontal axis of the histogram being time duration and the vertical axis of the histogram being frequency.

For example, the minimum boundary of the value range of the histogram may be determined as:

$$min = \{ \begin{matrix}μ - {α}_{3} * σ & if μ - {α}_{3} * σ > 0 \\ 0 & if μ - {α}_{3} * σ \leq 0\end{matrix}$$

and the maximum boundary of the value range of the histogram may be determined as:

$$max = \{ \begin{matrix}μ + {β}_{3} * σ & if μ + {β}_{3} * σ < length of window \\ legnth of window & if μ + {β}_{3} * σ \geq length of window\end{matrix}$$

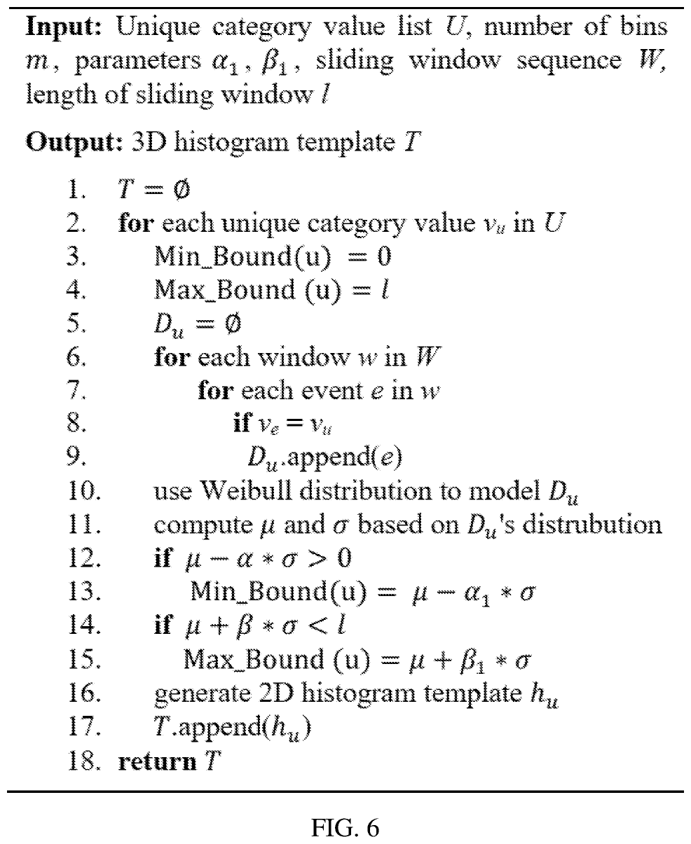

Once the sliding window and histograms are determined, the training time series data may be partitioned into a set of sliding time windows. If, for example, there are two categories associated with a given time series, then block 310 may generate two histograms for the time series, each with a respective sliding window with an appropriate window length. Additional detail on the generation of a histogram template is described below with respect to FIG. 6.

At a first time step, a subset of the time series may be considered according to the length of a sliding window. Instances of the associated category are identified within the window and respective durations are measured. Every time a duration for the category matches a bin in the histogram, the height of that bin may be incremented. The sliding window may then be moved to the next time step and the process may be repeated. The length of time between time steps may be determined according to a stride parameter. This process is repeated for each category that appears within the time series, with a respective sliding window length being used for each to generate a respective histogram.

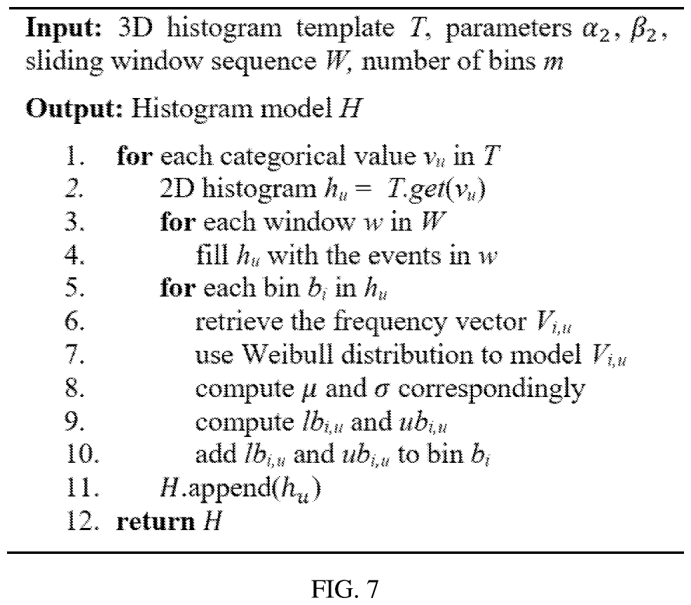

A model may be learned for every bin in each category. To learn the model for category vᵢ and bin bⱼ, a slice may be taken from the tensor to get a time series of n values by vᵢ and bⱼ. Using the optimal mean and standard deviation from the Weibull-approximated time series, the normal ranges of bin bⱼ in the model for category vᵢ, the upper and lower bounds can be determined as described above. Details on computing the histogram model are provided below with respect to FIG. 7.

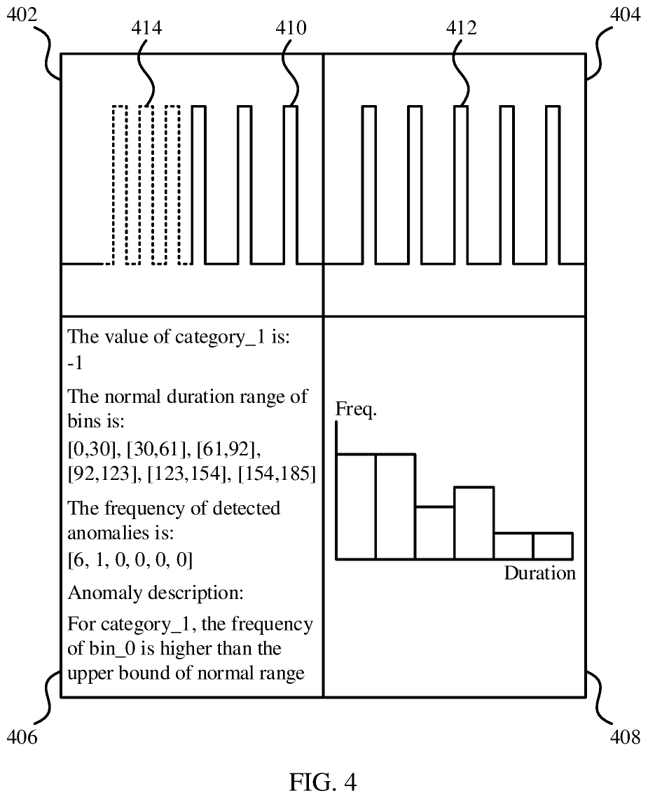

Referring now to FIG. 4, an exemplary comparison between observed data 402 and expected data 404 is shown. A user interface can display these two sets of data next to each other to allow for easy comparison, so that a human operator can better identify the cause of the problem. The user interface can also provide descriptions of the anomaly, including a textual analysis 406 and a histogram 408.

In the observed data 402 and the expected data 404 panes, respective time series for a same time period may be shown, including an observed time series 410 and an expected time series 412 made up of a series of values over time. The observed time series 410 may include a subset 414 that are indicated as being anomalous. The anomalous portion 414 may be graphically shown in a different manner, for example using a different color or line pattern. A remaining portion of the observed time series 410 may graphically resemble the corresponding values of the expected time series 412. The anomalous measurements can thereby be made clear and visible. Additional detail on how the baseline expected time series 412 is generated is described below.

The textual analysis 406 may include information about the observed time series 410 in the context of the expected time series 412, for example describing the bins of the histogram 408 and providing a description of the anomaly itself. The histogram 408 may display the various bins and their respective frequencies.

Referring now to FIG. 5, pseudo-code is shown for the determination of the sliding window length for a given sequence of sensor data R. After the initialization of the parameters in lines 1-3, the sensor data R is scanned and the total duration for m consecutive events is determined. The maximum duration is recorded as the window length. The sliding window sequence is then initialized and the data is scanned again. Subsequences of sensor data are retrieved by the length and the event sequence is generated from the data. The sliding window length and the generated window sequence are returned.

Referring now to FIG. 6, pseudo-code is shown for the generation of a histogram template. The histogram may have three dimensions: category, event duration, and frequency. Because the distributions of events' durations vary, the histogram may be made adaptive to handle event durations that do not fall in a Gaussian distribution. The Weibull distribution provides a continuous probability distribution that can simulate other distributions, particularly to approximate the distribution of events' durations and then determine a mean and standard deviation. As noted above, maximum and minimum bounds for the value ranges of the histogram may be determined.

Once the value range of the histogram is determined, the value range is divided into m equally distant bins for the histogram template. Lines 1-5 initialize the parameters and lines 6-9 generate the event list for each category value from the sliding window sequence. The Weibull distribution is used in lines 10-15 to approximate the data of each event list and the value range of the histogram template is determined based on an optimal mean and standard deviation. A histogram template is generated for the specific category and the template is added to the histogram set. After all categories have been processed, the set is returned. The template is filled with the events of a sliding window sequence.

By concatenating the three-dimensional histograms, a k×n×m tensor is generated, where k is the size of the unique category, n is the total number of sliding windows on historical data, and m is the number of bins in the histogram template. The value stored in the tensor is the count of the event's duration (e.g., its “frequency”) in each bin.

Referring now to FIG. 7, pseudo-code is shown for the calculation of the histogram model. A three-dimensional histogram template is provided as input. Fore ach categorical value, a two-dimensional histogram template is retrieved and filled with events in sliding windows of historical data. The frequency vector is retrieved by bin and category in lines 5 and 6 and the Weibull distribution is used to determine the mean and standard deviation. The range for frequency is determined and that information is filled to the model. The trained model is then returned.

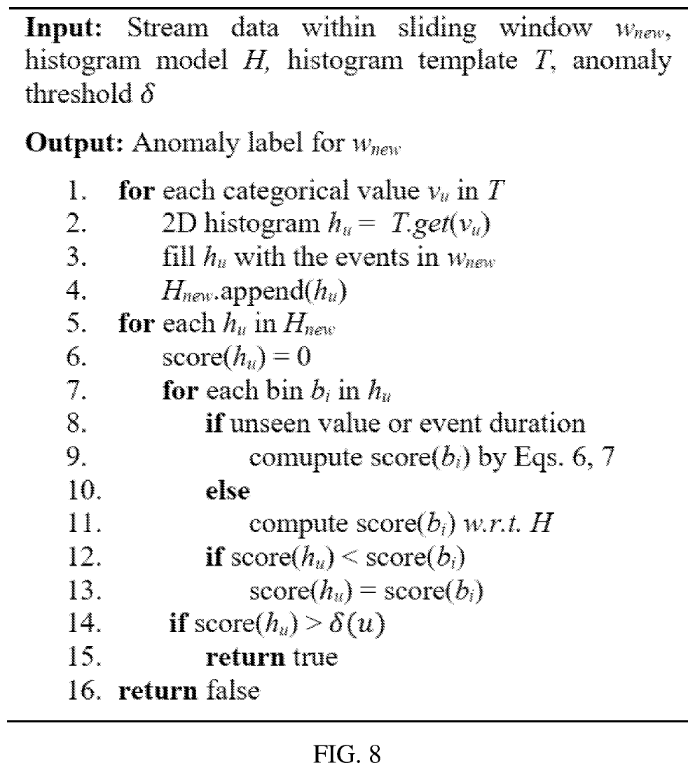

Referring now to FIG. 8, pseudo-code is shown for online monitoring of new sensor data. Event data from a new sliding window of the sensors' time series is filled into the histogram template to generate a new histogram for each categorical value. The generated histograms are matched to the trained model to compute an anomaly score for each bin of the histogram. The overall score of the histogram is determined to be the maximum score of all the bins. If the score of any category's histogram is larger than the threshold, an anomaly is detected. Otherwise, no anomaly is detected and monitoring continues.

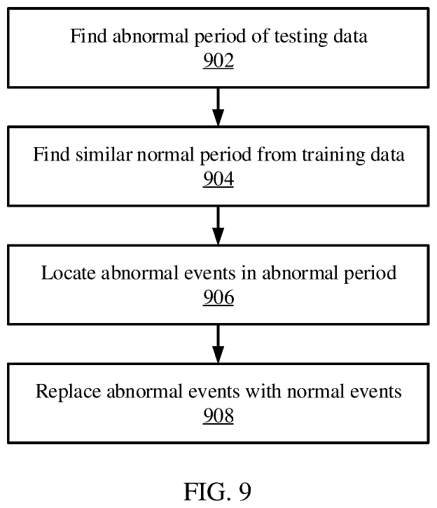

Referring now to FIG. 9, an exemplary computing device 900 is shown, in accordance with an embodiment of the present invention. The computing device 900 is configured to perform classifier enhancement.

The computing device 900 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 900 may be embodied as one or more compute sleds, memory sleds, or other racks, sleds, computing chassis, or other components of a physically disaggregated computing device.

Referring now to FIG. 9, detail on the generation of a baseline expected time series data is shown. For example, expected time series data may be shown as 412 in a user interface for identifying anomalous activity. As shown in FIG. 4, measured time series data 410 may be visually compared to the expected time series 412 to make discrepancies easy to see.

Block 902 identifies an abnormal period 414 from the measured time series data 410, for example using the anomaly scores described above. Block 904 finds a corresponding normal period from training data that is most similar to the measured anomaly data. Block 906 finds the start and end timestamps of abnormal events within the detected abnormal period. Block 908 replaces the abnormal events with normal baselines.

Finding the similar normal data in block 904 may use a sliding window to scan time series data, with trained models detecting anomalies in each window. The abnormal period may be evaluated based on the detected anomalies. To find a corresponding normal period, the period having the most similar distribution with the abnormal period is identified from the training data. The normal data may be used to replace the abnormal period from the measured data to generate an expected baseline time series.

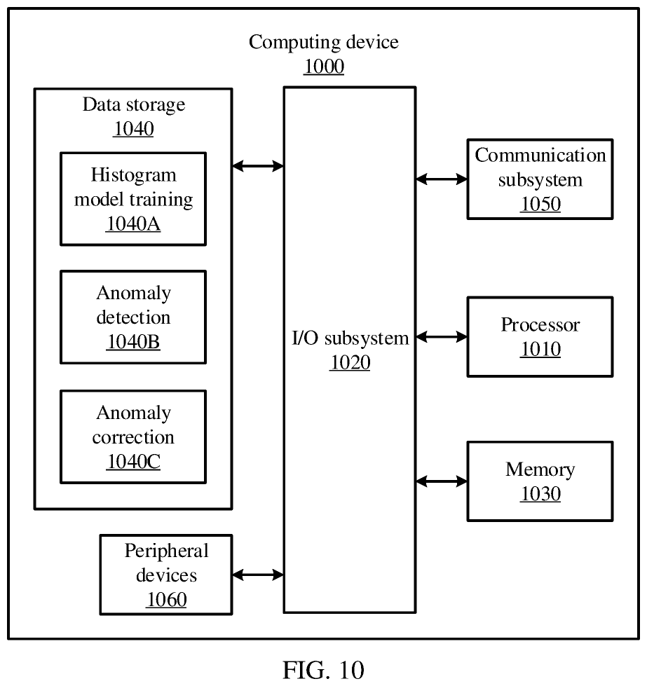

As shown in FIG. 10, the computing device 1000 illustratively includes the processor 1010, an input/output subsystem 1020, a memory 1030, a data storage device 1040, and a communication subsystem 1050, and/or other components and devices commonly found in a server or similar computing device. The computing device 1000 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 1030, or portions thereof, may be incorporated in the processor 1010 in some embodiments.

The processor 1010 may be embodied as any type of processor capable of performing the functions described herein. The processor 1010 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 1030 may be embodied as any type of volatile or non-volatile memory or data storage capable of performing the functions described herein. In operation, the memory 1030 may store various data and software used during operation of the computing device 1000, such as operating systems, applications, programs, libraries, and drivers. The memory 1030 is communicatively coupled to the processor 1010 via the I/O subsystem 1020, which may be embodied as circuitry and/or components to facilitate input/output operations with the processor 1010, the memory 1030, and other components of the computing device 1000. For example, the I/O subsystem 1020 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 1020 may form a portion of a system-on-a-chip (SOC) and be incorporated, along with the processor 1010, the memory 1030, and other components of the computing device 1000, on a single integrated circuit chip.

The data storage device 1040 may be embodied as any type of device or devices configured for short-term or long-term storage of data such as, for example, memory devices and circuits, memory cards, hard disk drives, solid state drives, or other data storage devices. The data storage device 1040 can store program code 1040 A for training a histogram model using training data that reflects normal operation of the monitored system 102, program code 1040B for detecting anomalies using new sensor data from the monitored system 102, and/or program code 1040C for automatically responding to correct or mitigate the anomalous operation of the monitored system 102. The communication subsystem 1050 of the computing device 1000 may be embodied as any network interface controller or other communication circuit, device, or collection thereof, capable of enabling communications between the computing device 1000 and other remote devices over a network. The communication subsystem 1050 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 1000 may also include one or more peripheral devices 1060. The peripheral devices 1060 may include any number of additional input/output devices, interface devices, and/or other peripheral devices. For example, in some embodiments, the peripheral devices 1060 may include a display, touch screen, graphics circuitry, keyboard, mouse, speaker system, microphone, network interface, and/or other input/output devices, interface devices, and/or peripheral devices.

Of course, the computing device 1000 may also include other elements (not shown), as readily contemplated by one of skill in the art, as well as omit certain elements. For example, various other sensors, input devices, and/or output devices can be included in computing device 1000, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1000 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for anomaly detection, comprising:
training an anomaly detection histogram model using historical categorical value data, including:
generating a histogram template based on historical categorical data;
converting the historical categorical data to a histogram using the histogram template; and
determining a normal range and anomaly threshold for the categorical data using the histogram.

2. The method of claim 1, wherein converting the historical categorical data to histograms includes approximating a distribution of event durations.

3. The method of claim 2, wherein approximating the distribution of event durations includes determining a Weibull distribution.

4. The method of claim 2, wherein converting the historical categorical data to histograms further includes determining a mean and a standard deviation from the approximated distribution of event durations.

5. The method of claim 2, wherein converting the historical categorical data to histograms further includes generating adaptive sliding windows over the categorical data.

6. The method of claim 2, wherein converting the historical categorical data includes identifying event durations based on periods of time that have a consistent categorical value.

7. The method of claim 1, wherein the anomaly detection histogram model includes a plurality of histogram bins corresponding to respective event duration ranges.

8. The method of claim 1, wherein the histogram is a three-dimensional histogram, including a dimension for each of category, event duration, and frequency.

9. A computer-implemented method for anomaly detection, comprising:
detecting an anomaly in a time series of categorical data values generated by a sensor, comprising:
framing the time series with a sliding window;
generating a histogram for the categorical data values using a histogram template;
generating an anomaly score for the time series using an anomaly detection histogram model on the generated histogram; and
comparing the anomaly score to an anomaly threshold; and
performing a corrective action responsive to the comparison.

10. The method of claim 9, wherein the anomaly detection histogram model includes a plurality of histogram bins corresponding to respective event duration ranges.

11. The method of claim 9, further comprising generating an explanation of an anomaly by comparing the time series to an expected time series.

12. The method of claim 9, further comprising displaying a visual depiction of the time series with a visual depiction of an expected time series.

13. The method of claim 12, further comprising generating the expected time series by identifying a similar time series from a set of training data and replacing abnormal events from the time series with normal events from the similar time series.

14. The method of claim 9, wherein generating the anomaly score includes setting an above-threshold anomaly score responsive to a categorical value that is not represented in the histogram model.

15. A system for anomaly detection, comprising:
a hardware processor; and
a memory that stores a computer program which, when executed by the hardware processor, causes the hardware processor to:
train an anomaly detection histogram model using historical categorical value data, including:
generation of a histogram template based on historical categorical data;
conversion of the historical categorical data to a histogram using the histogram template; and
determination of a normal range and anomaly threshold for the categorical data using the histogram; and
detect an anomaly in a time series of categorical data values generated by a sensor, including:
framing of the time series with a sliding window;
generation of a histogram for the categorical data values using a histogram template;
generation of an anomaly score for the time series using an anomaly detection histogram model on the generated histogram; and
comparison of the anomaly score to an anomaly threshold; and
perform a corrective action responsive to the comparison.

16. The system of claim 15, wherein the anomaly detection histogram model includes a plurality of histogram bins corresponding to respective event duration ranges.

17. The system of claim 15, wherein the generation of the histogram for the categorical data values includes approximating a distribution of event durations using a Weibull distribution.

18. The system of claim 15, wherein the histogram template is a three-dimensional histogram template, including a dimension for each of category, event duration, and frequency.

19. The system of claim 15, further comprising a user interface, wherein the computer program further causes the user interface to display a visual depiction of the time series with a visual depiction of an expected time series.

20. The system of claim 19, further comprising generating the expected time series by identifying a similar time series from a set of training data and replacing abnormal events from the time series with normal events from the similar time series.
